(19) United States
(12) Patent Application Publication
(10) Pub. No.: US 2006/0216673 A1
(43) Pub. Date: Sep. 28, 2006

(54) Dental implant

(76) Inventor: Kwang-Bum Park, Daegu-city (KR)

Correspondence Address: F. CHAU & ASSOCIATES, LLC, 130 WOODBURY ROAD, WOODBURY, NY, 11797, US

(21) Appl. No.: 10/555,974

(22) PCT Filed: Aug. 27, 2004
(86) PCT No.: PCT/KR04/02162

§ 371 Date: Nov. 8, 2005

(30) Foreign Application Priority Data
Aug. 29, 2003 (KR) 10-2003-0060414

(51) Int. Cl. A61C 8/00

(52) U.S. Cl. 433/173

(57) ABSTRACT

A dental implant comprises a fixture portion, a neck portion, and an abutment portion. The fixture portion is embedded in a jawbone. The fixture has a screw thread on an outer circumferential thereof. The neck portion is integrally formed on an upper end of the fixture portion and has a neck that is formed to be narrow such that the neck is bendable. The abutment portion is integrally formed on an upper end of the neck portion and has a cylindrical shape extending upwardly.

### BACKGROUND OF THE INVENTION

(a) Field of the Invention

The present invention relates to an artificial tooth system, and more particularly, to a dental implant having a fixture that is embedded in a jawbone and an abutment to which a dental prosthesis is mounted.

(b) Description of the Related Art

The term “dental implant” means a device for forming artificial teeth by inserting a metallic component having the shape of a tooth into a portion of a jawbone where teeth have been eliminated, maintaining the metallic component in place while new bone grows around the metallic component, and then mounting an artificial tooth to the metallic component. Types of implants can be divided into a under-periosteum type of implant, an inter-bone type of implant, a bone-passing type of implant, and the like, according to an embedded position thereof; and a screw-shaped implant, a cylindrically-shaped implant, and the like, according to an outer shape of the implant. Such implant can be used without grinding neighboring teeth and can prevent a jawbone from being damaged, thereby providing a basis for forming an efficient and aesthetic dental prosthesis.

Such implants may also be divided into a first type of implant that needs only a first operation for embedding a metallic component having the shape of a root of a tooth, and a second type of implant that needs a first operation and a second operation. For the second type of implant, a dental prosthesis is mounted after performing the first and the second operations.

In the case of the first type of implant a metallic portion is exposed in the oral cavity, but in the case of the second type of implant a metallic portion is exposed during the second operation for forming a natural shape of the gum by connecting a component having the shape of a tooth after the first operation. Therefore, the second type of implant has an aesthetic advantage over the first type of implant, but has a disadvantage that two operations are needed.

In particular, in the case of conventional two-stage operations for the implant, after embedding a fixture of the implant in a jawbone through a surgical operation, a time period of three to six months should elapse to allow new bone growth around the fixture, and then the second operation is performed and the final dental prosthesis is connected to the implant. Therefore, there is a problem that patients must endure inconvenience for a long time after embedding the implant. In addition, a disadvantage of the two-stage operations is that psychological and economic burdens of a patient are increased because of the two operations, and the operation process is complicated.

Efforts have been made to eliminate the second operation by connecting the final dental prosthesis to the implant during the first operation and there have been reports of success of such efforts, but complexities in the process of using tools for connection of the final dental prosthesis have only been improved a little bit due to improvements in design of the implant, and as such, complexities still remain.

Furthermore, although small, medium, and wide implants are manufactured according to embedded positions of the implant, most of the implants are designed to be suitable for a structure of a jawbone of Western people. Accordingly, an immediate loading implant that is suitable for use in front teeth of Eastern people having a small width and that may allow chewing by mounting the dental prosthesis immediately after embedding the implant is particularly needed, and there is a need for developing an implant that is easily ground and bent in an oral cavity of a patient.

### SUMMARY OF THE INVENTION

The present invention has been made in an effort to solve the above problems, and it is an object of the present invention to provide an immediate loading implant wherein a fixture and an abutment are integrally formed for immediate embedment after having a tooth extracted.

It is another object of the present invention to provide an implant having an improved pin type of structure so that coupling with bone tissue can be maximized, an initial bone recovery reaction is improved, and stress can be effectively dispersed during chewing.

It is further another object of the preset invention to provide an implant having an improved structure of an embedded portion, so that a height of the implant when it is embedded can be maintained after chewing.

To achieve the above object, the present invention provides a dental implant that is embedded in a jawbone and acts as an artificial tooth root to which a dental prosthesis such as an artificial tooth can be connected, comprising a fixture portion, a neck portion, and an abutment portion. The fixture portion is embedded in a jawbone. The fixture has a screw thread on an outer circumferential thereof. The neck portion is integrally formed on an upper end of the fixture portion and has a neck that is formed to be narrow such that the neck is bendable. The abutment portion is integrally formed on an upper end of the neck portion and has a cylindrical shape extending upwardly.

A lower portion of the fixture portion may be tapered downwardly with a degree of taper in a range of one to five degrees, and a 2-step cutting portion may be formed at a lower portion of the fixture portion.

The screw thread formed on the outer circumferential surface of the fixture portion may have a pitch of 0.6 mm and a pitch angle of 60 degrees.

A diameter Φn of the neck of the neck portion may be less than an average diameter of the fixture portion, where the average diameter Φs of the fixture portion is defined as an average diameter of a portion including the screw thread, except the tapered portion.

In another embodiment of the present invention, the average diameter Φs of the fixture portion may be in a range of 1.5 to 2.0 mm, and the diameter Φn of the neck may be about 90% of the average diameter Φs of the fixture portion.

In a further embodiment of the present invention, the average diameter Φs of the fixture portion may be in a range of 2.0 to 3.3 mm, and the diameter of the neck Φn may be about 80% of the average diameter Φs of the fixture portion.

The abutment portion has at least one insertion groove being formed along a longitudinal direction of the abutment portion and extending to an upper end of the abutment portion with a predetermined width and a predetermined length, and the insertion groove is provided as a pair of insertion grooves that are formed to be symmetrical with respect to a center axis of the fixture portion.

The at least one insertion groove may have a flat bottom surface, and the bottom surface may be tapered such that a thickness of the fixture portion at the bottom surface decreases as it approaches an upper end of the fixture portion.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a partial sectional view of an implant according to an embodiment of the present invention;

FIG. 2 is a sectional view along a line II-II in FIG. 2;

FIG. 3 is a top view shown from a direction of III; and

FIG. 4 shows a state that an implant according to an embodiment of the present invention is embedded in a jawbone.

### DETAILED DESCRIPTION OF THE PREFERRED EMBODIMENTS

Embodiments of the present invention will now be explained such that those skilled in the art may easily execute the present invention.

Preferred embodiments of the present invention will now be described in detail with reference to the accompanying drawings.

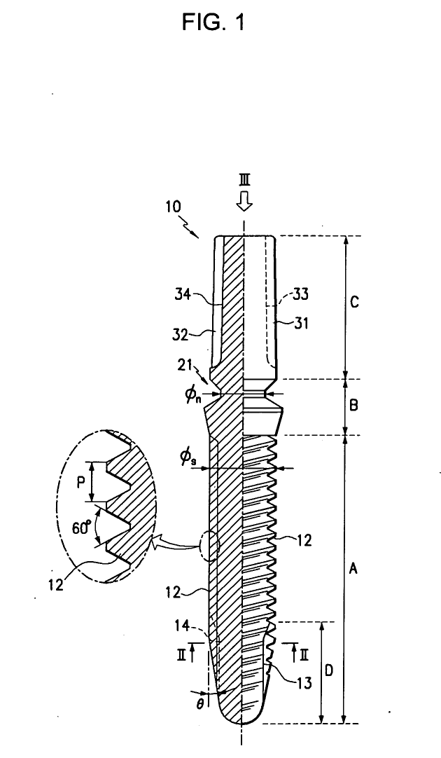

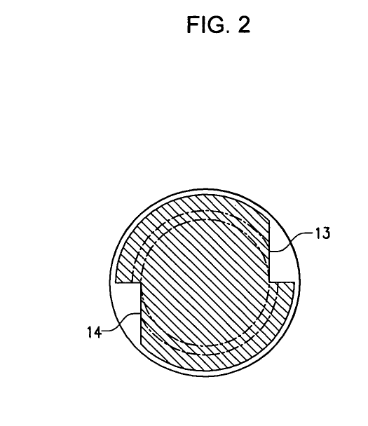

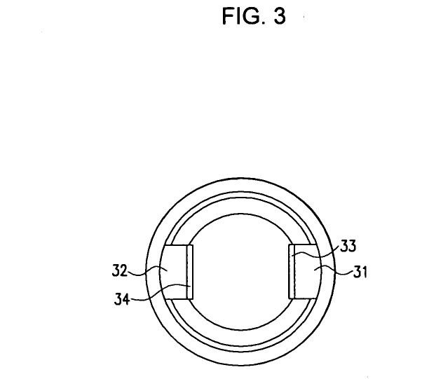

FIG. 1 is a partial sectional view of an implant according to an embodiment of the present invention, FIG. 2 is a sectional view along a line II-II in FIG. 2, and FIG. 3 is a top view shown from a direction of III.

As illustrated in FIG. 1, an implant 10 according to an embodiment of the present invention includes a fixture portion A, a neck portion B, and an abutment portion C.

The fixture portion A that is positioned at a lower portion of the implant 10 is inserted into a tissue of a jawbone, and has screw threads 12 on an outer circumferential surface thereof. The fixture portion A having the screw threads 12 is inserted into a drilled hole formed in a jawbone. The screw threads 12 are preferably formed as a standard screw thread form having a pitch (P) of 0.6 mm, and a pitch angle of 60°, as illustrated in FIG. 1, so that a stress caused by an occlusion force can be easily dispersed. In FIG. 1, an illustration of the screw thread 12 is given as a simplification of the drawing at a portion of a cut-away surface.

A lower portion of the fixture portion A is tapered downwardly, and the degree of taper is preferably in the range of one to five degrees. In addition, as illustrated in FIGS. 1 and 2, a 2-step cutting portion D having a predetermined length is fabricated at a lower portion of the fixture portion A. The cutting portion D can be formed by forming a pair of cutting grooves 13 and 14, which are symmetric with reference to a center axis of the fixture portion A, at a portion of an outer surface of the fixture portion A through a cutting process along a longitudinal direction of the implant 10 to a predetermined depth. At this time, preferably, the cutting grooves 13 and 14 are formed perpendicularly, and the above-stated tapered portion is formed corresponding to the cutting portion D. By forming the tapered portion and the cutting portion D at a lower potion of the fixture portion A, a guide of the implant and self-tapping function are achieved easily while the implant 10 is inserted into a drilled hole formed in a jawbone. However, the scope of the present invention is not limited to this embodiment, and more than two cutting holes may also be formed for a suitable guide of the implant.

The neck portion B is integrally formed on an upper end of the fixture portion A, the neck portion B includes a neck 21 that is formed to be narrow such that the diameter Φn of the neck 21 is less than the average diameter Φs of the fixture portion A. At this time, the average diameter Φs of the fixture portion A is defined as an average diameter of a portion including the screw thread, except the tapered portion.

The diameter of the fixture portion A is preferably in the range of 1.5 to 3.3 mm, and the length of the fixture portion A is preferably in the range of 10.0 to 15.0 mm.

In order for the implant according to an embodiment of the present invention to have a temporary function, the diameter of the fixture portion A is preferably in the range of 1.5 to 2.0 mm. In this case, preferably, the diameter Φn of the neck 21 is 90% of the average diameter Φs of the fixture portion A.

On the other hand, in order for the implant according to an embodiment of the present invention to have a permanent function, the diameter of the fixture portion A is preferably in the range of 2.0 to 3.3 mm. In this case, preferably, the diameter Φn of the neck 21 is 80% of the average diameter Φs of the fixture portion A.

Because the diameter of the fixture portion A is relatively small in a case when the implant according to an embodiment of the present invention is used for a temporary implant, the implant can be easily removed from a jawbone. Additionally, because a ratio of the diameter of the neck of the temporary implant to the average diameter of the fixture portion A is relatively greater than the permanent implant, the neck portion of the temporary implant has structural strength as well as good bending characteristics.

Such neck portion B is formed to be easily bendable while avoiding stress concentration and breakdown, so that appropriate arrangement with respect to rows of upper and lower teeth can be made. That is, because the neck portion of the implant according to an embodiment of the present invention is bendable by having a narrow part, position compensation is possible according to an occlusion between upper and lower teeth after the implant is embedded. Preferably, the diameter Φn of the neck 21 is about 2.0 mm. In addition, the neck portion is made of a material of Grade 3 CP-Titanium having good toughness such that it is bendable. Under these conditions, the neck portion can be bent by about 15 degrees.

The abutment portion C is integrally formed on an upper end of the neck portion B, and has a cylindrical shape extending upwardly from the neck portion B. In addition, the abutment portion C may be tapered upwardly at a predetermined angle within the range of one to 10 degrees. The abutment portion C can be cut according to an occlusion condition within the oral cavity of a patient.

In addition, as shown in FIGS. 1 and 3, a pair of insertion grooves 31 and 32 with a predetermined width and a predetermined depth are formed in the abutment portion C. The insertion grooves 31 and 32 are formed along a longitudinal direction of the abutment portion C and are extended to a top end of the abutment portion C, and they are disposed to be symmetrical to each other with respect to a center axis of the abutment portion C. Such insertion grooves 31 and 32 are formed in order to increase a coupling force with the dental prosthesis.

Bottom surfaces 33 and 34 of the insertion grooves 31 and 32 are preferably flat. In addition, as illustrated in FIG. 2, the bottom surfaces 33 and 34 are preferably tapered upwardly and inwardly such that a thickness of the abutment at the bottom surfaces 33 and 34 of the insertion grooves 31 and 32 (i.e., a distance between the bottom surfaces 33 and 34) decreases as it is approaches an upper end of the abutment portion C. Therefore, because of a reverse rotation of the dental prosthesis that is coupled the abutment portion C, a coupling force with the dental prosthesis substantially increases.

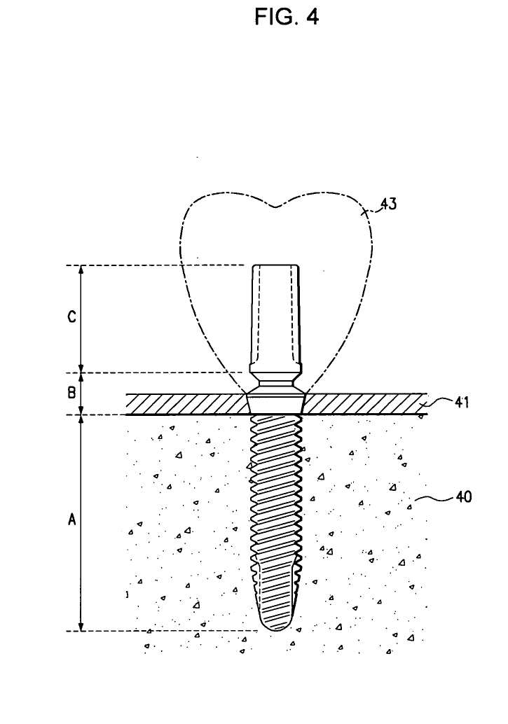

FIG. 4 shows a state in which an implant according to an embodiment of the present invention is embedded in a jawbone.

As shown in FIG. 4, the fixture portion A of the implant 10 is embedded in a jawbone 40, and the neck portion B is approximately positioned near a gum 41. The abutment portion C is exposed outside the gum 41, and an artificial tooth 43, which is the final dental prosthesis, is coupled to the abutment portion C, completing the artificial tooth system.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

According to the dental implant of the embodiment of the present invention, by integrally forming the fixture that is embedded in a jawbone and the abutment for connecting a dental prosthesis, embedment of the implant is possible without removing a mucous membrane and the periosteum, so that pain due to the operation, a possibility of infection, and a time to perform the operation for embedding the implant can decrease. In addition, because an initial fixing time is relatively short, it is suitable for a jawbone having a small amount of bone and for a case of loss of front teeth having a relatively small width.

Furthermore, because the neck portion that has a relatively small diameter is formed between the fixture member that is embedded in a jawbone and the abutment portion that is exposed outside a gum, and a position of the abutment portion can be easily changed according to a row of teeth, good aesthetic characteristics can be achieved and the operation becomes easy.

Still furthermore, because a screw thread of a standard screw type may be formed along the entire side wall of the fixture portion, stress caused by an occlusion force can be easily dispersed, so that it is also possible to attach a dental prosthesis just after the displacement of the implant.

In addition, because an insertion groove is formed at an upper portion of the implant, the dental prosthesis can be firmly attached to the implant.

1. A dental implant that is embedded in a jawbone and acts as an artificial tooth root to which a dental prosthesis such as an artificial tooth can be connected, the dental implant comprising:
a fixture portion being embedded in a jawbone, the fixture portion having a screw thread on an outer circumferential thereof;
a neck portion being integrally formed on an upper end of the fixture portion and having a neck that is formed to be narrow such that the neck is bendable; and
an abutment portion being integrally formed on an upper end of the neck portion and having a cylindrical shape extending upwardly.

2. The dental implant of claim 1, wherein a lower portion of the fixture portion is tapered downwardly with a degree of taper in a range of one to five degrees.

3. The dental implant of claim 1, wherein a 2-step cutting portion is formed at a lower portion of the fixture portion.

4. The dental implant of claim 1, wherein the screw thread formed on the outer circumferential surface of the fixture portion has a pitch of 0.6 mm and a pitch angle of 60 degrees.

5. The dental implant of claim 1, wherein a diameter Φn of the neck of the neck portion is less than an average diameter of the fixture portion, where the average diameter Φs of the fixture portion is defined as an average diameter of a portion including the screw thread, except the tapered portion.

6. The dental implant of claim 5, wherein the average diameter Φs of the fixture portion is in a range of 1.5 to 2.0 mm.

7. The dental implant of claim 6, wherein the diameter Φn of the neck is about 90% of the average diameter Φs of the fixture portion.

8. The dental implant of claim 5, wherein the average diameter Φs of the fixture portion is in a range of 2.0 to 3.3 mm.

9. The dental implant of claim 8, wherein the diameter of the neck Φn is about 80% of the average diameter Φs of the fixture portion.

10. The dental implant of claim 5, wherein the average diameter Φs of the fixture portion is in a range of 1.5 to 3.3 mm, wherein the diameter of the neck Φn is about 90% of the average diameter Φs of the fixture portion when the average diameter Φs of the fixture portion is in a range of 1.5 to 2.0 mm, and wherein the diameter of the neck Φn is about 80% of the average diameter Φs of the fixture portion when the average diameter Φs of the fixture portion is in a range of 2.0 to 3.3 mm.

11. The dental implant of claim 1, wherein the abutment portion has at least one insertion groove being formed along a longitudinal direction of the abutment portion and extending to an upper end of the abutment portion with a predetermined width and a predetermined length, and the insertion groove is provided as a pair of insertion grooves that are formed to be symmetrical with respect to a center axis of the fixture portion.

12. The dental implant of claim 11, wherein the at least one insertion groove has a flat bottom surface, and wherein the bottom surface is tapered such that a thickness of the fixture portion at the bottom surface decreases as it approaches to an upper end of the fixture portion.
